(19) United States
(12) Patent Application Publication
(10) Pub. No.: US 2002/0033669 A1
(43) Pub. Date: Mar. 21, 2002

(54) Plasma display panel and method of manufacturing the same

(75) Inventors: Yoshikazu Kanazawa, Kawasaki (JP); Shigeki Kameyama, Kawasaki (JP); Takeshi Kuwahara, Kawasaki (JP)

Correspondence Address: STAAS & HALSEY LLP, 700 11TH STREET, NW, SUITE 500, WASHINGTON, DC, 20001, US

(73) Assignee: FUJITSU HITACHI PLASMA DISPLAY LIMITED, Kawasaki (JP)

(21) Appl. No.: 09/949,632

(22) Filed: Sep. 12, 2001

(30) Foreign Application Priority Data
Sep. 19, 2000 (JP) 2000-283751

(51) Int. Cl. H01J 17/49

(52) U.S. Cl. 313/582

(57) ABSTRACT

A rear substrate with a plurality of second discharge electrodes formed thereon is disposed so to face a front substrate with a plurality of first discharge electrodes formed thereon. A display area is formed in a part where the first discharge electrodes of the front substrate and the second discharge electrodes of the rear substrate face each other. A sealing member is disposed in between the peripheral parts of the front substrate and the rear substrate, and the substrates are laminated to each other via the sealing member. A shielding member is disposed between the display area and the sealing member. By disposing the shielding member in the plasma display panel, an area outside the display area of the rear substrate is not visible from the front substrate side, thereby improving the quality of appearance of the plasma display panel.

### BACKGROUND OF THE INVENTION

1. Field of the Invention

The present invention relates to a plasma display panel.

2. Description of the Related Art

Plasma display panels (hereinafter, also referred to as PDPs) are display panels of self-luminous type, and are receiving attention as display panels that replace CRTs (Cathode Ray Tubes) by virtue of their high visibility and low profiles. A PDP is formed by filling discharge gas into a space of the order of 100 microns sandwiched between two glass substrates (a front substrate 12 and a rear substrate 16 described later) which are provided with electrodes. One of the glass substrate is coated with phosphors. Then, a voltage higher than or equal to a starting voltage is applied between the electrodes to cause a discharge, and the ultraviolet rays generated from the discharge make the phosphors excitation-luminous for pixel luminescence.

FIG. 1 shows an overview of one PDP 10 called a surface-discharge alternating-current type among PDPs of this kind, in which sustain discharge is created between a pair of discharge electrodes.

The PDP 10 includes a plurality of pairs of display electrodes 14 which extend in the horizontal direction of the diagram, and a plurality of address electrodes 18 which are orthogonal to these display electrodes 14. The display electrodes 14 are formed on a front substrate 12. The address electrodes 18 are formed on a rear substrate 16 facing the front on the substrate 12. Terminals 20 are formed ends of the display electrodes 14 and the address electrodes 18. A display area D is formed on the intersection part of the display electrodes 14 and the address electrodes 18. A sealing member 22 is arranged in between and on the periphery of the substrates 12 and 16. The substrates 12 and 16 are laminated to each other via the sealing member 22.

FIG. 2 shows the details of the display area D of the PDP 10.

A pair of discharge electrodes 14 forms a display line L in the PDP 10. A predetermined gap is arranged between neighboring display lines L so that the display electrodes 12 will not cause any accidental discharge across the two lines. In order to avoid a drop in bright room contrast ratio due to external light reflection, a black stripe 24 is formed in this gap.

The display electrodes 14 include transparent electrodes 26 and nontransparent bus electrodes 28 formed on these transparent electrodes 26. The transparent electrodes 26 are formed of tin oxide (SnO2) or ITO (a transparent conductor consisting mainly of indium oxide), and have a relatively high resistance. The bus electrodes 28 are formed of metal such as copper. These bus electrodes 28 lower the resistances of the display electrodes 14.

Meanwhile, ribs 30 are formed between the address electrodes 18, along these address electrodes 18. Then, the regions surrounded by the black stripes 24 and the ribs 30 form cells C, or light emission units.

FIG. 3 shows a cross-sectional view of the PDP 10.

The display electrodes 14 and the black stripes 24 (not shown) are formed on the side with the discharge space 32 of the front substrate 12 which lies on the observer side to make a display surface. A dielectric layer 34 for holding a wall charge is formed over the display electrodes 14 and the black stripes 24.

The address electrodes 18 and the ribs 30 are formed on the side with the discharge space 32 of the rear substrate 16. A dielectric layer 36 is formed over the address electrodes 18. The ribs 30 are formed on this dielectric layer 36. Phosphor layer (not shown) is formed over the inclined planes of the ribs 30 and the dielectric layer 36 surrounded by the ribs 30. The phosphor layer emits light by the incidence of discharge-generated ultraviolet rays.

Then, the substrates 12 and 16 are laminated to each other via the sealing member 22, so that the discharge space 32 is sealed.

In the above-described PDP 10, before displaying pixels, a reset pulse is applied between the display electrodes 14 to make a reset discharge and initialize the cells (reset period). Then, scan pulses are applied to address electrodes 18 that correspond to data to be displayed, thereby selecting cells C to emit light (address period). Then, sustain pulses are applied to between the display electrodes 14 over periods corresponding to the brightness gradations, to make a sustain discharge for the selected cells C (sustentation period). Ultraviolet rays generated from the sustain-discharge excite the phosphor layer to emit light. Then, the light is transmitted through the transparent electrodes 26 and the front substrate 12 to radiate out to the exterior, thereby displaying an image.

FIG. 4 shows an overview of a plasma display panel apparatus 38 (hereinafter also referred to as a PDP apparatus) into which the above-mentioned PDP 10 is incorporated.

The PDP apparatus 38 is structured by accommodating the PDP 10 in a case 40 having an opening 40a. The opening 40a is generally formed with enough room for the display area D of the PDP 10. Therefore, not only the display area D of the PDP 10, but also a gap S which is formed between the display area D and the sealing member 22 can be seen from the opening 40a. The width of the gap S is approximately 10 mm to 30 mm, which is undesired for the quality of appearance. For this reason, a polyester film or the like is often laminated to cover the gap S in order to enhance the appearance of the PDP apparatus 38.

FIG. 5 shows an example of laminating a black polyester film 44 or the like inside an optical filter 42 which is attached to the opening 40a of the case 40, along the periphery of the opening 40a.

FIG. 6 shows an example of laminating the black film 44 directly to the periphery of the outer side of the front substrate 12 of the PDP 10.

FIG. 7 shows an example of forming a wide black stripe 24a in the gap S, when forming the black stripes 24.

FIG. 8 shows an example of forming a wide rib 30a in the gap S, when forming the ribs 30.

In the PDP apparatus, however, it is necessary to separate the PDP 10 and the optical filter 42 by about 10 mm in order to dissipate heat of the PDP 10. Therefore, in the structure shown in FIG. 5, there is a problem that the gap S is visible when the display area D is viewed from a slanting direction as shown in the arrow.

In the structure shown in FIG. 6, it is difficult to laminate the film 44 straight when the PDP 10 is large. Further, there is a possibility that the film 44 which is laminated to the PDP 10 comes into contact with the case, tools and the like to be damaged thereby, in accommodating the PDP 10 into the case of the PDP apparatus. When the film 44 is damaged, a new film 44 needs to be laminated thereto.

In the structure shown in FIG. 7, the black stripe 24a can be easily formed in the gap S along an extending direction of the display electrodes 14, but there is a problem that the black stripe 24a cannot be formed in the gap S which is orthogonal to the extending direction of the display electrodes 14. This is because the black stripe 24a and the display electrodes 14 come into direct contact with each other when the black stripe 24a is formed orthogonal to the extending direction of the display electrodes 14. When the black stripe 24a comes into contact with the display electrodes 14, a chemical reaction occurs between the material of the black stripe 24a and the material of the display electrodes 14, which may cause a disadvantage of breakage of the display electrodes 14.

In the structure shown in FIG. 8, there is a possibility that the height of the rib 30a (corresponding to an orthogonal direction of the rear substrate 16) becomes higher than that of the ribs 30, when the rib 30a which is wider than the ribs 30 is formed with the ribs 30. As this result, space is left between the ribs 30 and the front substrate 12 to prevent stable operation of the PDP 10. Further, there is a problem that the strength of the PDP 10 is reduced because it is impossible to keep the ribs 30 and the front substrate 12 in close contact with each other.

### SUMMARY OF THE INVENTION

It is an object of the present invention to improve quality of appearance of a plasma display panel. In particular, it is an object of the present invention to improve the quality of appearance of the plasma display panel without substantially increasing the fabrication cost. Further, it is an object of the present invention to improve the quality of appearance of the plasma display panel without lowering its reliability.

According to one of the aspects of the present invention, a rear substrate with a plurality of second discharge electrodes formed thereon is disposed so to face a front substrate with a plurality of first discharge electrodes formed thereon. A display area is formed in a part where the first discharge electrodes of the front substrate and the second discharge electrodes of the rear substrate face each other. A sealing member is disposed in between the peripheral parts of the front substrate and the rear substrate, and the substrates are laminated to each other via the sealing member. A shielding member is disposed between the display area and the sealing member.

In a fabrication process of the plasma display panel, the plurality of the first discharge electrodes and the second discharge electrodes are first formed on the front substrate and the rear substrate, respectively. Next, the shielding member is disposed between the display area and the peripheral part of the front substrate or between the display area and the peripheral part of the rear substrate. It should be mentioned that the display area is formed in the part where the first discharge electrodes of the front substrate and the second discharge electrodes of the rear substrate face each other. Thereafter, the sealing member is disposed on either the peripheral part of the front substrate or the peripheral part of the rear substrate so that the front substrate and the rear substrate are laminated to each other.

Thus, by disposing the shielding member in the plasma display panel, an area outside the display area of the rear substrate is not visible from the front substrate side, thereby improving the quality of appearance of the plasma display panel. For example, when the color of the shielding member is allowed to be almost the equal to that of the display area observed through the front substrate when discharge is not yet created, the boundary of the display area and the area outside thereof becomes inconspicuous. Further, when the reflectance ratio of the shielding member is allowed to be almost the equal to that of the display area observed through the front substrate when discharge is not yet created, the boundary of the display area and the area outside thereof also becomes inconspicuous.

Since the shielding member is disposed inside the plasma display panel, it is possible to prevent the shielding member from being damaged by coming into contact with the case and the like, in incorporating the plasma display panel into the case of the plasma display panel apparatus. The formation/disposition of the shielding member are not necessary in the fabrication process of the plasma display panel apparatus, which makes it possible to prevent the fabrication process of the plasma display panel from becoming complicated due to the shielding member being applied. The fabrication process of the shielding member is different from that of the display electrode or the like, and hence the shielding member can be formed with high accuracy.

Since the shielding member is disposed on the front substrate (or the rear substrate) on which the first discharge electrodes (or the second discharge electrodes) are formed in advance, it is unnecessary to change the fabrication process of the front substrate and the rear substrate formed the discharge electrodes thereon. Hence, the quality of the discharge electrodes or the like is not reduced due to the shielding member being applied.

According to another aspect of the present invention, a shielding member is formed by a combination of a plurality of rectangular members. The plasma display panel is easily formed by respectively disposing the rectangular members between the display area and the sealing member, and laminating the front substrate and the rear substrate by the sealing member. The rectangular members can be formed easily and inexpensively, which makes it possible to prevent substantial increase in the fabrication cost of the plasma display panel by the application of the shielding member.

According to another aspect of the present invention, a shielding member is formed integrally in a shape of a frame (i.e. shape of a picture frame). The plasma display panel is easily formed by disposing the shielding member between the display area and the sealing member, and laminating the front substrate and the rear substrate by the sealing member.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a plane view showing a conventional plasma display panel;

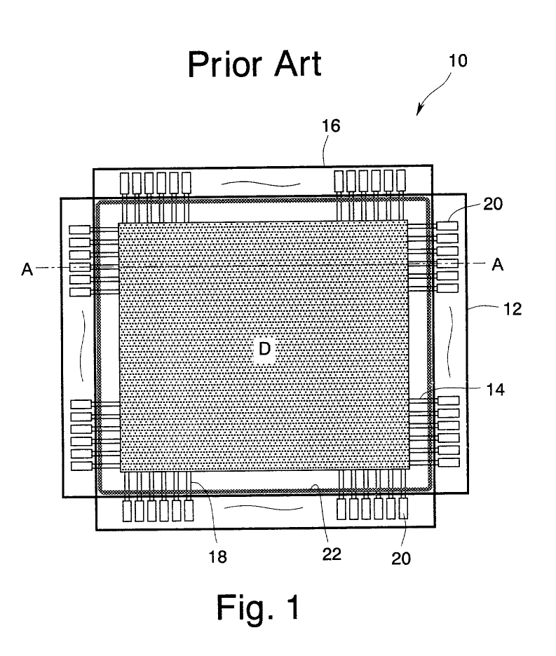

FIG. 2 is a plane view showing a main part in FIG. 1;

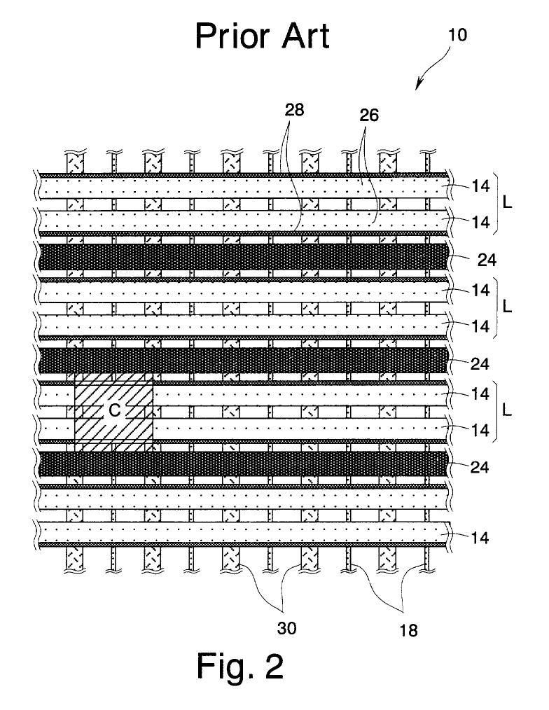

FIG. 3 is a sectional view taken along the A-A line in FIG. 1;

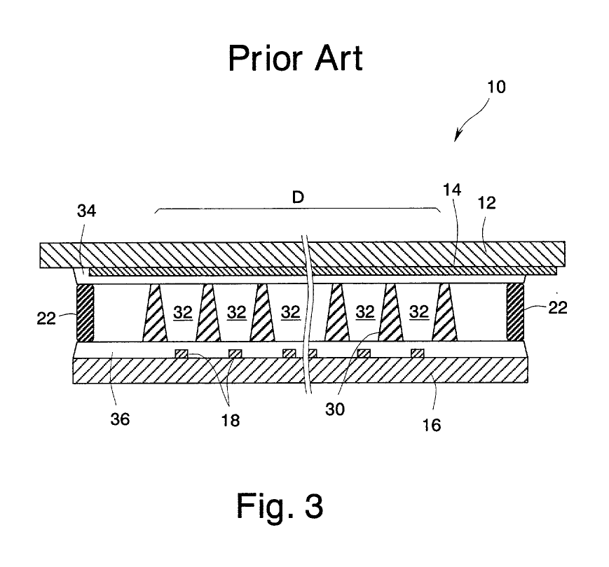

FIG. 4 is a plane view showing a plasma display panel apparatus into which the plasma display panel in FIG. 1 is applied;

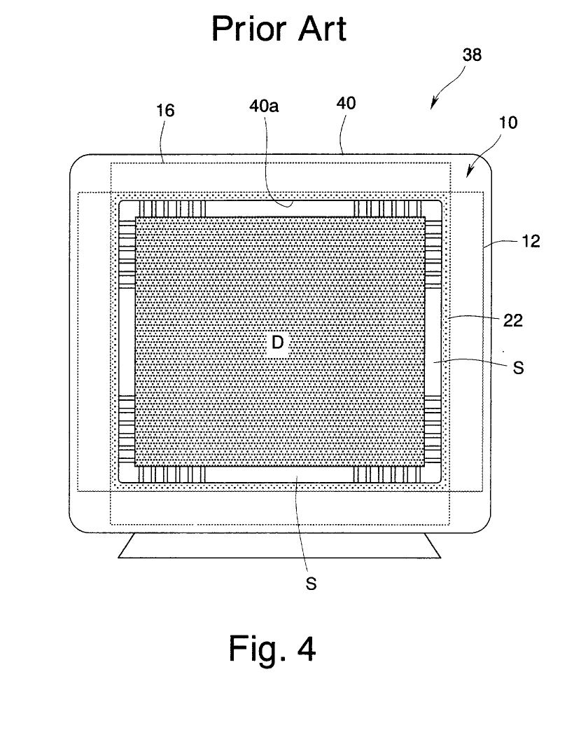

FIG. 5 is a sectional view showing an example of a conventional plasma display panel apparatus;

FIG. 6 is a sectional view showing an example of a conventional plasma display panel;

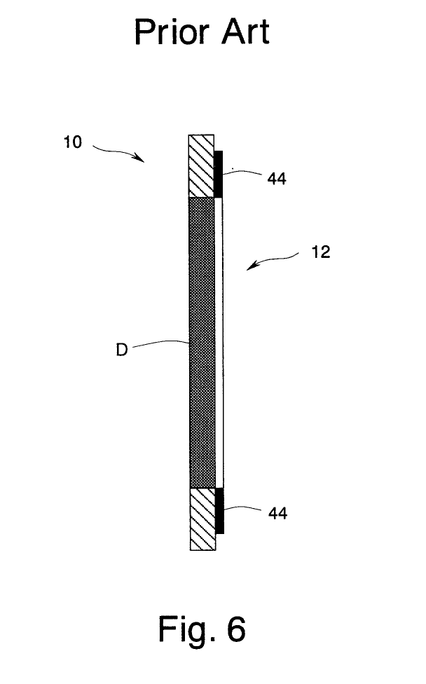

FIG. 7 is a sectional view showing another example of a conventional plasma display panel;

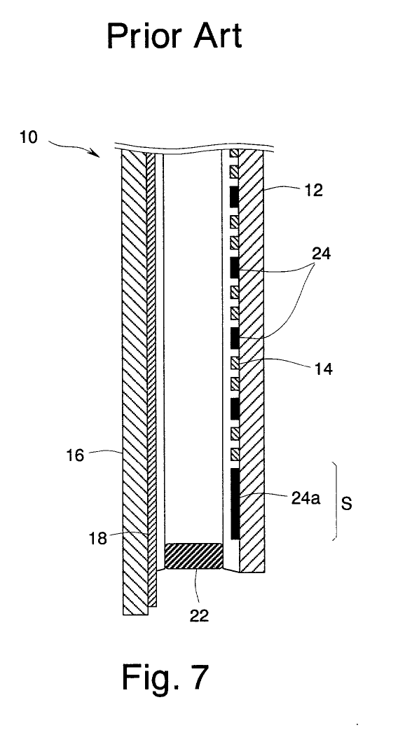

FIG. 8 is a sectional view showing still another example of a conventional plasma display panel;

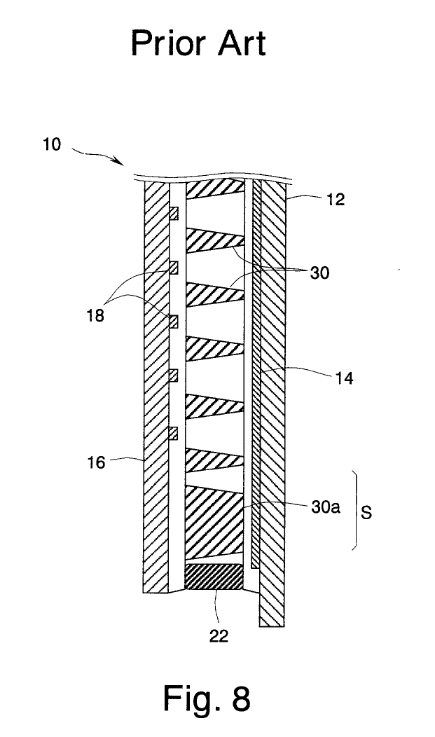

FIG. 9 is a plane view showing a first embodiment of a plasma display panel according to the present invention;

FIG. 10 is a sectional view taken along the A-A line in FIG. 9;

FIG. 11 is an explanatory view showing a method of manufacturing the plasma display panel in FIG. 9;

FIG. 12 is an explanatory view showing the method of manufacturing the plasma display panel in FIG. 9;

FIG. 13 is a plane view showing a plasma display panel apparatus into which the plasma display panel in FIG. 9 is applied;

FIG. 14 is a block diagram of the plasma display panel apparatus in FIG. 13; and

FIG. 15 is a plane view showing a second embodiment of the plasma display panel according to the present invention.

### DESCRIPTION OF THE PREFERRED EMBODIMENTS

Hereinafter, preferred embodiments of the present invention will be explained with reference to the drawings.

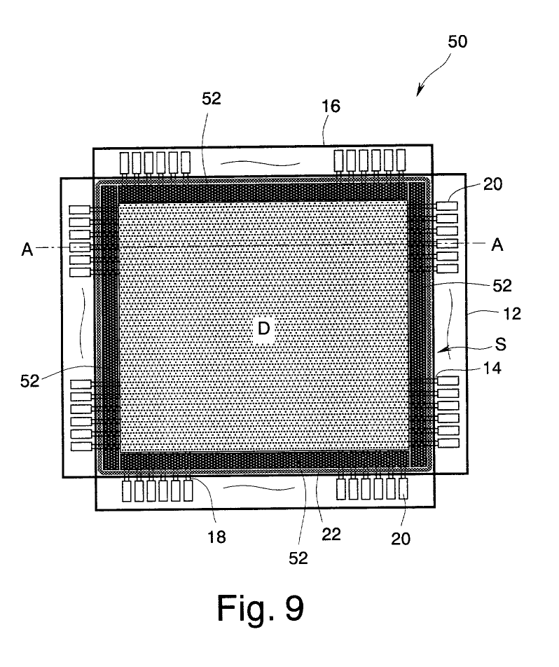

FIG. 9 shows a first embodiment of a plasma display panel according to the present invention. Incidentally, the same numerals and symbols are given to the same components as those explained in the Description of the Related Art, and detailed explanations thereof are omitted.

This embodiment is formed from a PDP 50 of a surface-discharge alternating current type.

The PDP 50 includes a plurality of display electrodes (discharge electrodes) 14 which are formed on a front substrate 12 to extend in a horizontal direction in the drawing, and a plurality of address electrodes (discharge electrodes) 18 which are formed on a rear substrate 16 facing the front substrate 12, to be orthogonal to the display electrodes 14. Terminals 20 are formed at end parts of the display electrodes 14 and the address electrodes 18. A display area D is formed in the intersecting part (part facing each other) of the display electrodes 14 and the address electrodes 18. The front substrate 12 and the rear substrate 16 are laminated to each other by a sealing member 22 which is disposed on a peripheral part of the substrates 12 and 16. The sealing member 22 is formed of, for example, glass.

There is a gap S between the peripheral part of the front substrate 12 and the rear substrate 16 on which the sealing member is disposed and the display area D. Four rectangular shielding sheets 52 are disposed in the gap S. The shielding sheet 52 is formed of a glass which is colored black and has a thickness of about 100 μm. The glass is formed by using the same material with that of dielectric layers 34 and 36 which will be described later. A manufacturing process of the shielding sheet 52 is different from a fabrication process of the discharge electrode such as the display electrode 14, a rib 30 and the like. The shielding sheets 52 prevent the rear substrate 16 from being seen directly from the front substrate 12 side.

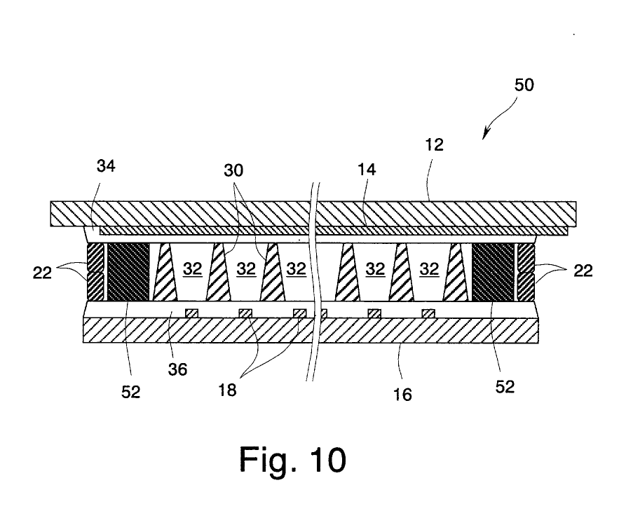

FIG. 10 is a sectional view of the PDP 50.

The display electrodes 14 and not-shown black stripes are formed on a discharge space 32 side of the front substrate 12 which is located on an observer side to make a display surface. The dielectric layer 34 for holding a wall charge is formed to cover the display electrodes 14 and the black stripes 24. A protection layer (not shown) which is made of magnesium oxide (MgO) or the like is formed on the dielectric layer 34.

The address electrodes 18 and the rib 30 are formed on the discharge space 32 side of the rear substrate 16. The dielectric layer 36 is formed to cover the address electrodes 18, and the ribs 30 are formed on the dielectric layer 36. The height of the respective ribs 30, that is, an interval of the dielectric layers 34 and 36 is set as 130 μm (design value). For this reason, the shielding sheets 52 whose thickness is 100 μm are supported by frictional force which is generated by a part thereof coming into contact with the dielectric layers 34 and 36.

A not-shown phosphor layer is formed over inclined planes of the ribs 30 and the dielectric layer 36 surrounded by the ribs 30. The phosphor layer emits light by the incidence of ultraviolet rays generated by discharge. The front substrate 12 and the rear substrate 16 are laminated to each other via the sealing member 22 so that the discharge space 32 is sealed.

Incidentally, the display electrodes 14 cannot hide themselves by the shielding sheets 52 because these are located on the front substrate 12 side from the shielding sheets 52. However, most display electrodes 14 are transparent electrodes, and hence the quality of appearance is not reduced because of the display electrodes 14.

Next, the assembly process of the aforesaid PDP 50 will be explained.

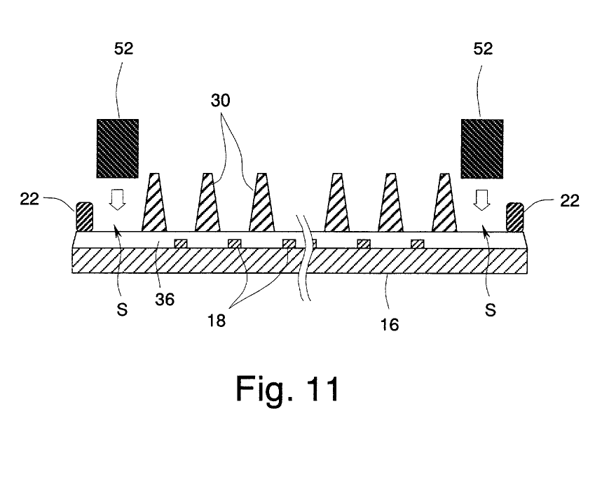

First, as shown in FIG. 11, the sealing member 22 is disposed on the peripheral part of the rear substrate 16 on which the address electrodes 18 and the ribs 30 are formed. Next, the four shielding sheets 52 are mounted in due order on the gap S which is formed between the ribs 30 and the sealing member 22. The shielding sheets 52 may be disposed so that the respective end parts come into contact with each other, thereby eliminating the need for complicated positioning.

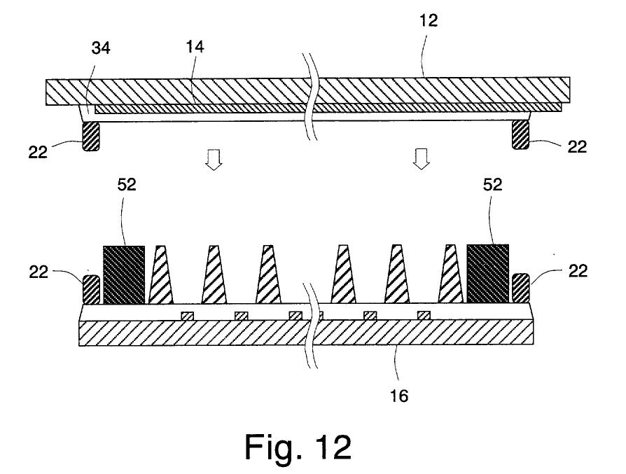

Next, as shown in FIG. 12, the front substrate 12 on which the display electrodes 14 and the sealing member 22 are formed is mounted on the rear substrate 16. Then, each sealing member 22 is welded together to laminate the front substrate 12 and the rear substrate 16 to each other, and thus the PDP 50 as shown in FIG. 10 is completed.

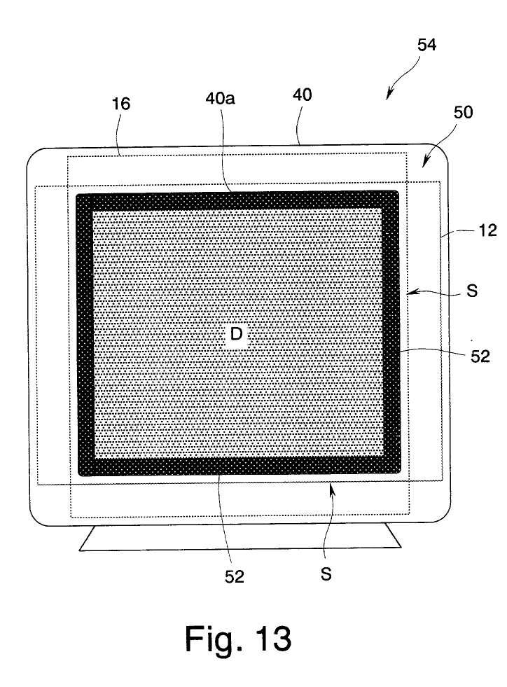

FIG. 13 is a view showing an overview of a plasma display panel apparatus 54 (hereinafter also referred to as PDP apparatus 54) into which the above-mentioned PDP 50 is incorporated.

The PDP apparatus 54 is structured by accommodating the PDP 50 in a case 40 having an opening 40a. Since the shielding sheets 52 are disposed in the gap S, the rear substrate 16 cannot be seen from the front substrate 12 side through the gap S. As a result, the quality of appearance of the PDP 50 and the PDP apparatus 54 is improved. Further, the PDP 50 and the PDP apparatus 54 appear sharply because the black-colored shielding sheets 52 are used.

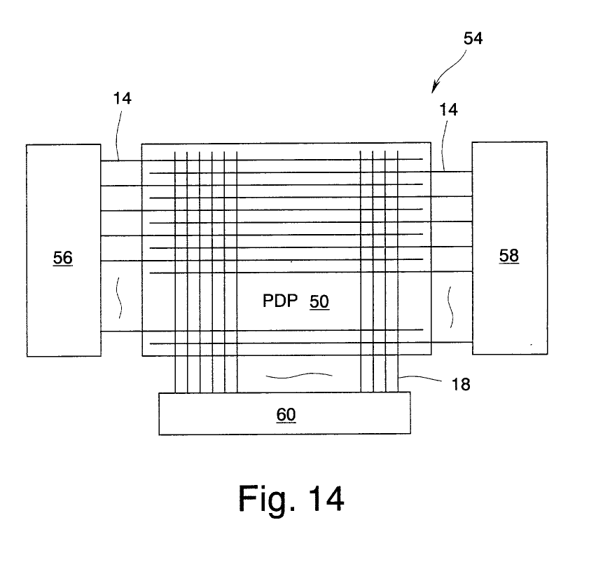

FIG. 14 shows a control circuit of the PDP apparatus 54.

The PDP apparatus 54 includes a first driving circuit 56 which drives the odd-numbered display electrodes 14, a second driving circuit 58 which drives the even-numbered display electrodes 14, and a third driving circuit 60 which drives the address electrodes 18.

In the PDP apparatus 54, the first driving circuit 56 and the second driving circuit 58 first apply reset pulses between the display electrodes 14 to make a reset discharge. Cells are initialized by the reset discharge (reset period). Then, the third driving circuit 60 applies scan pulses to the address electrodes 18 corresponding to data to be displayed, thereby selecting cells C to emit light (address period). Then, the first driving circuit 56 and the second driving circuit 58 apply sustain pulses between the adjacent display electrodes 14 over a period corresponding to the brightness gradation to make a sustain discharge for the selected cells C (sustain period). Ultraviolet rays generated by the sustain discharge make the phosphor layer excitation-luminous. Then, light passes through the front substrate 12 to radiate out to the outside, thereby displaying an image.

As described above, by using the plasma display panel according to this embodiment, the shielding sheets 52 prevent the rear substrate 16 from being seen from the front substrate 12 side through the gap S. As this result, it is possible to improve the quality of appearance of the plasma display panel.

Since the shielding sheets 52 are disposed inside the PDP 50, it is possible to prevent the shielding sheets 52 from being damaged by coming into contact with the case 40 and the like, when the PDP 50 is incorporated into the case 40 of the PDP apparatus 54. The formation/disposition of the shielding sheets 52 are not necessary in the assembly process of the PDP apparatus 54, which makes it possible to prevent the assembly process of the PDP apparatus 54 from becoming complicated. The manufacturing process of the shielding sheet 52 is different from the fabrication processes of the display electrode 14, the address electrode 18, the rib 30 or the like, and hence the shielding sheet 52 can be formed with high accuracy.

Since the shielding sheets 52 are disposed between the front substrate 12 on which the display electrodes 14 and the like are formed in advance and the rear substrate 16, it is unnecessary to change the fabrication process of forming the display electrodes 14 and so on.

The thickness of the shielding sheets 52 is allowed to be smaller than the height (design value) of the ribs 30, so that top parts of the respective ribs 30 can come into contact with the front substrate 12 without fail, even when the heights of the ribs 30 change due to dispersion in manufacture. Therefore, the display area D can be divided by the ribs 30 into a plurality of luminous areas without fail. Further, since the sealing member 22 and the ribs 30 lie between the substrates 12 and 16 to support these, the strength of the PDP 50 is not decreased by applying the shielding sheets 52 thereto.

The rectangular shielding sheets 52 can be formed easily and inexpensively, which makes it possible to prevent substantial increase in the fabrication cost of the PDP 50.

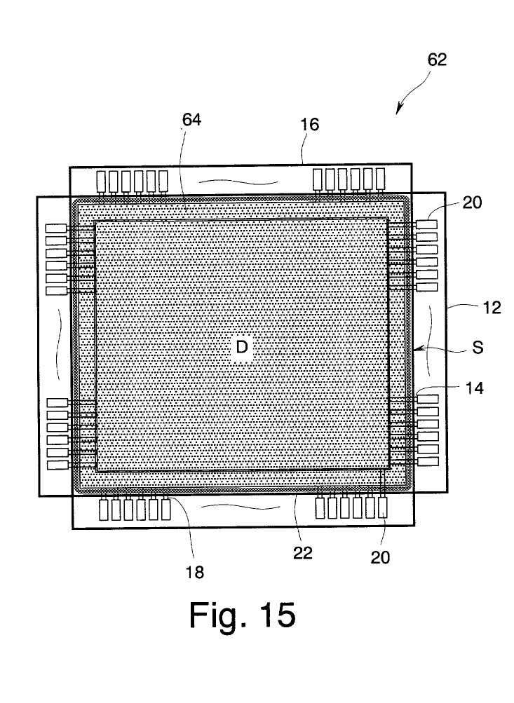

FIG. 15 shows a second embodiment of a plasma display panel according to the present invention. Incidentally, the same numerals and symbols are given to the same components as those explained in the Description of the Related Art and the first embodiment, and detailed explanations thereof are omitted.

In this embodiment, a shielding sheet 64 is different from the shielding sheet 52 in the first embodiment. The rest of the structure is the same as that of the first embodiment.

The shielding sheet 64 is formed by one frame-shaped (picture frame-shaped) sheet which corresponds to the shape of the gap S. Therefore, the shielding sheet 64 can be easily disposed in the gap S. The shielding sheet 64 is formed of glass, whose color and reflectance ratio are almost the equal to those of the display area D, which are observed through the front substrate 12, while discharge is not yet created. For this reason, the boundary of the display area D and the area outside thereof becomes inconspicuous.

It is also possible to produce effects in this embodiment, which are similar to those in the first embodiment. Further, since the shielding sheet 64 is integrally formed in this embodiment, the shielding sheet 64 can be easily disposed in the gap S.

Moreover, the color and the reflectance ratio of the shielding sheet 64 is allowed to be almost the equal to those of the display area D, which are observed through the front substrate 12, while discharge is not yet created, and therefore, it is possible to make the boundary of the display area D and the area outside thereof inconspicuous.

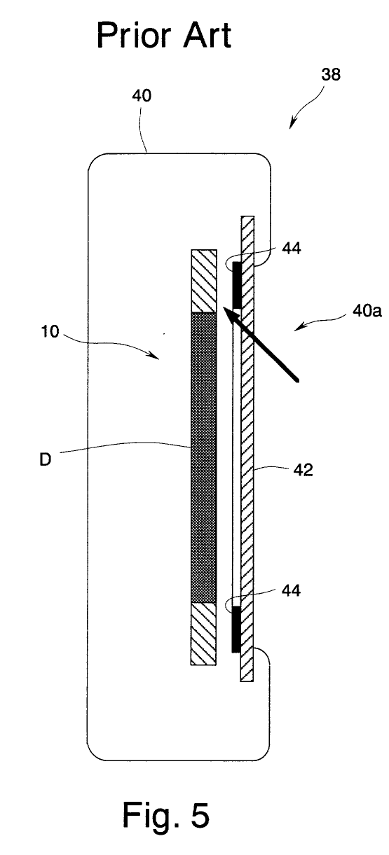

Incidentally, in the above embodiments, the example of applying the present invention to the PDP in which the sustain discharge is created between a pair of the display electrodes is explained. The present invention is, however, not limited to the above embodiments. For example, the present invention may be applied to a PDP (PDP having the black stripes 22 as shown in FIG. 5 and so on) of an ALIS (Alternate Lighting of Surfaces technology) type. An overview of the PDP of the ALIS type is disclosed in the Patent Office Gazette of Japanese Patent No. 2801893.

In the above embodiments, the example of forming the shielding sheets 52 and 64 by the glass is explained. The present invention is, however, not limited to the above embodiments. The shielding sheets 52 and 64 can be made of any material which has predetermined shielding performance, and does not react with the ribs 30, the dielectric layers 34 and 36, the protection layer on the dielectric layer 34 (for example, MgO), the sealing member 22 and the discharge gas.

In the above-mentioned first embodiment, the example of forming the PDP 50 by mounting the shielding sheets 52 on the rear substrate 16 is explained. The present invention is, however, not limited to the above embodiment. For example, it is possible to mount the shielding sheets 52 on the front substrate 12 to form the PDP 50.

In the above-mentioned first embodiment, the example of using the shielding sheets 52 which are colored black is explained. The present invention is, however, not limited to the above embodiment. The color of the shielding sheets 52 may be selected according to the design of the PDP apparatus and preferences.

In the above-mentioned first embodiment, the example of covering all the four sides of the gap S by using the four shielding sheets 52 is explained. The present invention is, however, not limited to the above embodiment. It is possible to dispose the shielding sheets 52 in, for example, only the three sides of the gap S, if the quality of appearance is not reduced.

In the above-mentioned first embodiment, the example of supporting the shielding sheets 52 in the PDP 50 by the frictional force. The present invention is, however, not limited to the above embodiment. For example, the shielding sheets 52 may be adhered to the inside of the PDP 50.

The invention is not limited to the above embodiments and various modifications may be made without departing from the spirit and scope of the invention. Any improvement may be made in part or all of the components.

What is claimed is:

1. A plasma display panel, comprising:
a front substrate;
a rear substrate disposed so to face said front substrate;
a sealing member disposed between said front substrate and said rear substrate, for laminating peripheral parts of the substrates; and
a shielding member disposed in a space between said sealing member and a display area formed.

2. The plasma display panel according to claim 1, wherein said shielding member is formed by a combination of a plurality of rectangular members.

3. The plasma display panel according to claim 1, wherein said shielding member is integrally formed and is in a shape of a frame.

4. The plasma display panel according to claim 1,
wherein color of said shielding member is almost identical to the color of the display area observed through said front substrate when no discharge is generated.

5. The plasma display panel according to claim 1, wherein reflectance ratio of said shielding member is almost equal to the reflectance ratio of the display area observed through said front substrate when no discharge is generated.

6. A method of fabricating a plasma display panel comprising a front substrate and a rear substrate disposed so to face the front substrate, the method comprising the steps of:
disposing a shielding member between peripheral parts of the front substrate and the rear substrate and a display area; and
laminating the front substrate to the rear substrate by a sealing member disposed on said peripheral parts.
